(19) United States
(12) Patent Application Publication
(10) Pub. No.: US 2006/0103132 A1
(43) Pub. Date: May 18, 2006

(54) Tube seal

(76) Inventors: John W. Hardin, Medina, TN (US); Mark W. Wood, Jackson, TN (US)

Correspondence Address: THE BLACK & DECKER CORPORATION, 701 EAST JOPPA ROAD, TW199, TOWSON, MD, 21286, US

(21) Appl. No.: 11/057,706

(22) Filed: Feb. 14, 2005

Related U.S. Application Data
(60) Provisional application No. 60/544,380, filed on Feb. 12, 2004.

(51) Int. Cl. F16L 5/00

(52) U.S. Cl. 285/192

(57) ABSTRACT

A tube seal for a pressure vessel includes a body, a seal groove and a tube retention collar. The body has an aperture formed therein for receiving a tube. The body also has an external surface and an internal surface. The seal groove is disposed in the external surface of the body for securing the body within an orifice formed in a wall of the pressure vessel. The tube retention collar is disposed on the internal surface of the body for engaging the tube and securing the tube within the tube seal. Pressure within the pressure vessel causes the body to deform about and engage the tube retention collar with the tube to secure the tube within the aperture.

### CROSS-REFERENCE TO RELATED APPLICATIONS

The present application claims priority under 35 U.S.C. § 119(e) to U.S. Provisional Application No. 60/544,380 entitled: Tube Seal, filed Feb. 12, 2004, which is hereby incorporated by reference in its entirety.

### FIELD OF THE INVENTION

The present invention relates generally to the field of pressure vessels such a compressed air storage tanks used by air compressors and the like, and in particular, to a tube seal for coupling a tube to such pressure vessels and sealing the orifice formed in the pressure vessel for receiving the tube.

### BACKGROUND OF THE INVENTION

Air compressors employ a compressor for compressing air that is then stored in an air storage tank for use in powering air powered tools, inflating tires, providing pressurized air to run machinery, or the like. Currently, when a tube or tube-like structure is coupled to a pressure vessel, such as the compressed air storage tank of an air compressor, an orifice is first formed in the vessel. A flange having a threaded fitting is then welded to the wall of the pressure vessel within the orifice. The end of the tube to be coupled to the pressure vessel is coupled to a compression nut which is tightened into the threaded fitting for securing the tube to the pressure vessel.

Such assembly requires the use of skilled welders or expensive robotic welding equipment for welding the flange to the tank. The weld must further be inspected for weld quality and leakage. Consequently, attachment of tubes to pressure vessels such as compressed air storage tanks via such welded fittings is expensive and time consuming. Moreover, compression nuts used for securing the tube to the fitting may loosen over time allowing air to escape from the pressure vessel reducing the efficiency of the air compressor.

Consequently, it would be advantageous to provide a tube seal for coupling a tube or a tube-like structure to a pressure vessel that would require less assembly labor, reduce machining cost, and lower material cost.

### SUMMARY OF THE INVENTION

Accordingly, the present invention is directed to a tube seal for coupling a tube or tube-like structure to a pressure vessel and sealing the orifice formed in the pressure vessel for receiving the tube. In exemplary embodiments, the tube seal includes a body having an aperture formed therein for receiving a tube. A seal groove is disposed in an external surface of the body for securing the body within an orifice formed in a wall of the pressure vessel such as the compressed air storage tank of an air compressor, or the like. A tube retention collar is disposed on an internal surface of the body within the aperture for engaging the tube and securing the tube within the body. Pressure within the pressure vessel causes the body to deform about the tube for engaging the tube retention collar with the tube to secure the tube within the aperture. In exemplary embodiments, the tube seal may further comprise a check valve a unidirectional flow of fluid through the tube or may be used for coupling tubular structures such as drain valves or the like to the vessel.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1A is an exploded isometric view depicting the attachment of a tube to the compressed air storage tank of an air compressor via a tube seal in accordance with an exemplary embodiment of the present invention;

FIG. 1B is an isometric view of the tube seal shown in FIG. 1A from the outside surface of the air storage tank of the air compressor depicting the tube installed in the tube seal;

FIG. 1C is an isometric view of the tube seal shown in FIG. 1A from the inside surface of the air storage tank of the air compressor depicting the tube received in the tube seal;

FIG. 2A is isometric view illustrating a tube seal including a check valve and a spring assembly according to an exemplary embodiment of the present invention;

FIG. 2B is an isometric view of the tube seal shown in FIG. 2A from the outside surface of the vessel wall depicting a tube received in the tube seal;

FIG. 2C is an isometric view of the tube seal shown in FIG. 2A from the inside surface of the vessel wall showing a tube received in the tube seal;

FIG. 3 is an isometric view depicting a drain valve assembly employing a tube seal in accordance with an embodiment of the present invention;

FIG. 4 is an isometric view of a tube seal shown in FIG. 1A;

FIG. 5 is a cross-sectional side elevation view of a tube seal and tube shown in FIG. 1A;

FIG. 6 is a cross-sectional side elevation view of a tube seal in accordance with a second exemplary embodiment of the present invention; and

FIG. 7 is a cross-sectional side elevation view of a tube seal shown in FIG. 6.

### DETAILED DESCRIPTION OF INVENTION

Reference will now be made in detail to the presently preferred embodiments of the invention, an example of which is illustrated in the accompanying drawings.

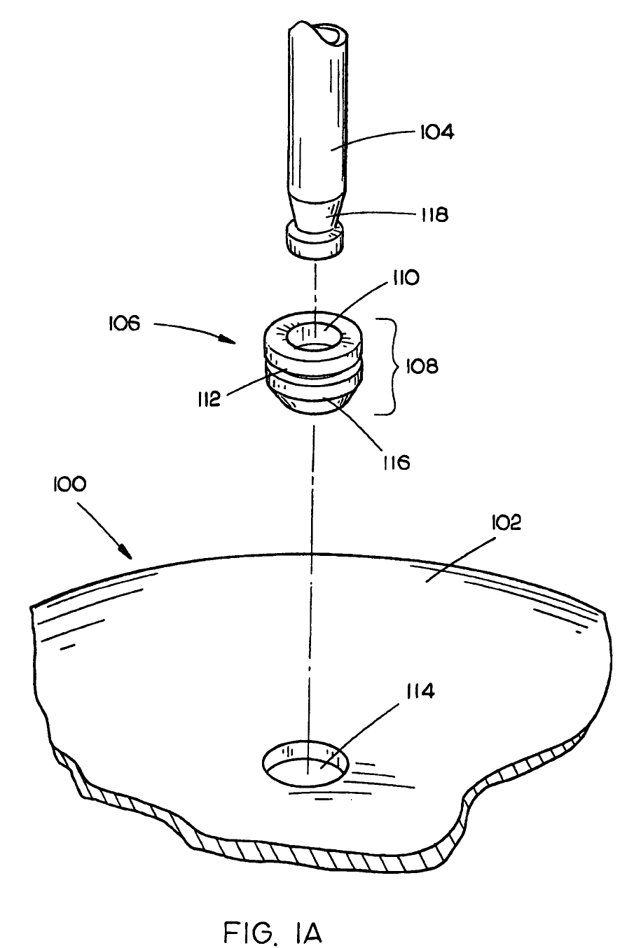

FIGS. 1A through 7 illustrate a tube seal in accordance with exemplary embodiments of the present invention. The tube seal of the present invention may be used as a connection for a pressure vessel. For example, the tube seal may serve as a compressor outlet tube connection, an air receiver-to-manifold tube connection, and various other manifold connections such as connections to gauges, pressure switches, safety valves, regulators, quick connects, and the like. In exemplary embodiments, the pressure vessel is an air storage tank of an air compressor.

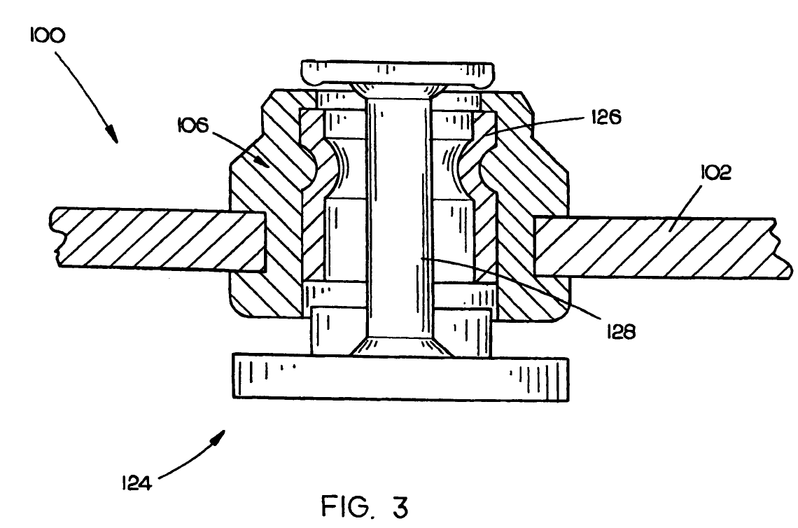

FIGS. 1A through 1C and 5 illustrate an air compressor including the tube seal in accordance with the preferred embodiment. The air compressor 100 includes a pressure vessel or air storage tank 102 for storing air under pressure. A tube 104, such as an outlet tube, formed of copper, brass, aluminum, steel or the like, is included for at least one of supplying compressed air to the air storage tank 102 and removing compressed air from the air storage tank 102. The tube seal 106 couples the tube to the air storage tank 102.

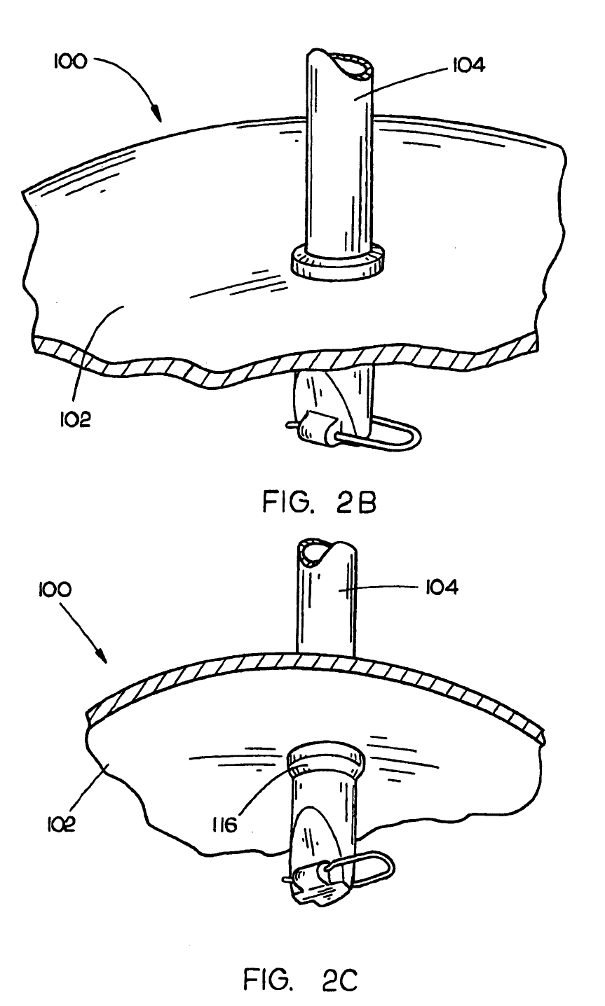

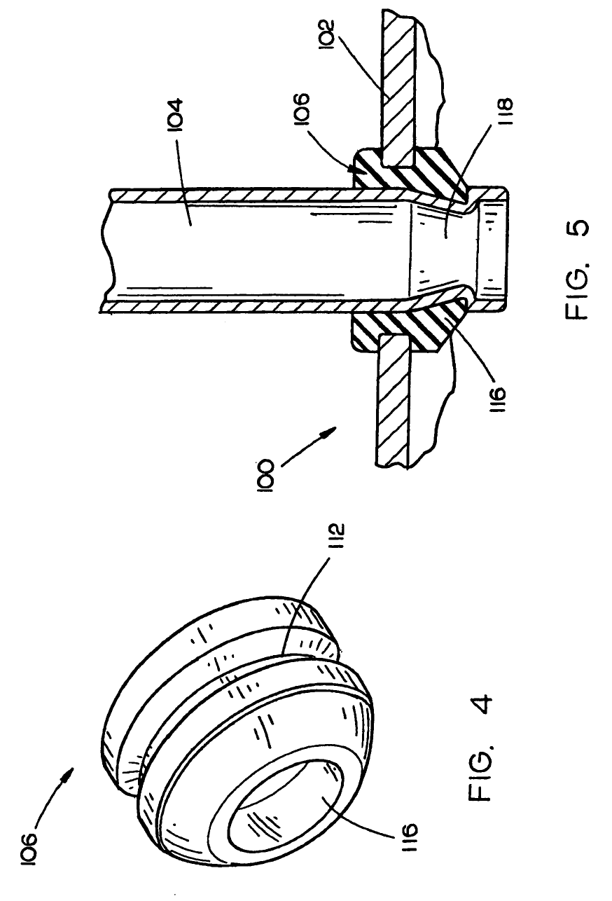

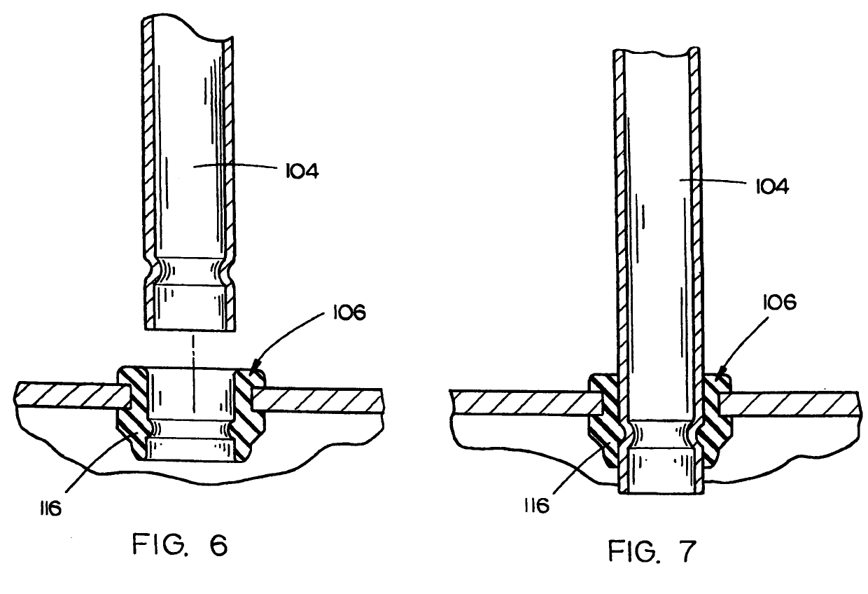

The tube seal 106 includes a body 108 having an external surface and an internal surface. As shown, the body 108 of the tube seal 106 includes an aperture 110 formed there through for receiving the tube 104 to be coupled to the pressure vessel 102. A seal groove 112 is disposed in the external surface of the body 108 for securing the body 108 within an orifice 114 formed in a wall of the air storage tank 102. A tube retention collar 116 (also shown in FIG. 4) is disposed on the internal surface of the body 108. The tube retention collar 116 engages the tube 104 and secures the tube within the tube seal 106. In further embodiments, additional tube retention collars 116 may be added to the tube seal 106 to increase the radial clamping force on the tube 104. The seal groove 112 engages the wall of the air storage tank 102 so that the tube retention collar 116 is located within the air storage tank 102. In the preferred embodiment, the tube retention collar 116 comprises a generally ramped or conical surface and a tube engaging face (shown in FIG. 5) for engaging a channel 118 formed in an external surface of the tube 104. The channel 118 includes a second generally ramped or conical surface and a seal engaging face (shown in FIG. 5) for engaging the tube engaging face of the retention collar 116. Pressure within the air storage tank 102 causes the body 108 to deform about the tube 104 for engaging the tube retention collar 116 with the tube 104 to secure the tube 104 within the body 108. Further, the tube 104, when installed, reinforces the tube seal 106 by preventing it from collapsing inward under pressure. The corresponding construction of the tube seal 106 and the tube 104 of the preferred embodiment prevents the tube 104 from becoming dislodged from the tube seal 106 in high pressure working environments. Alternatively constructed embodiments of the tube seal 106 and tube 104, are illustrated in FIGS. 6 and 7.

In one embodiment, the body 108 is formed of an elastomer material for allowing elastic deformation of the body 108. For example, in one specific embodiment, the body may be formed of silicone. However, it will be appreciated that the body may be formed of any suitable elastomer, including fluoroelastomers, and the like, without departing from the scope and intent of the present invention. The elasticity of the body 108 allows the tube seal 106 to be pressed into the orifice 114 formed in the wall of the air storage tank 102 for easier installation. Compared to the tube seal of the present invention, prior tube attachment techniques are more costly and time consuming because they employ a threaded fitting welded into the wall of the pressure vessel in which they are implemented.

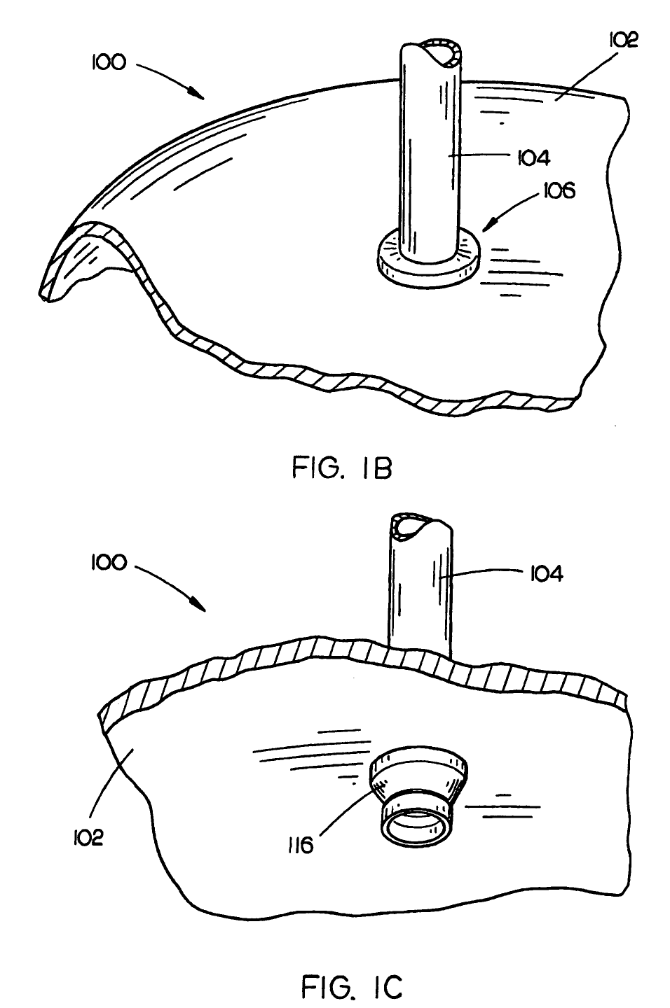

FIGS. 2A-2C illustrate a tube seal 106 having a check valve 120 for providing a unidirectional flow of air through the tube 104. The check valve portion may be constructed of an elastomer material such as silicone, a fluoroelastomer, or the like. In the illustrated embodiments, the check valve 120 comprises a duck-bill check valve. It is contemplated that the check valve of the present invention may be a style other than the duck-bill check valve. In further embodiments, a spring assembly 122 is included for biasing the check valve 120 to one of an opened or closed position. Such configuration improves valve sealing under extreme temperatures and may decrease valve closing time, thereby enhancing performance during high frequency operation.

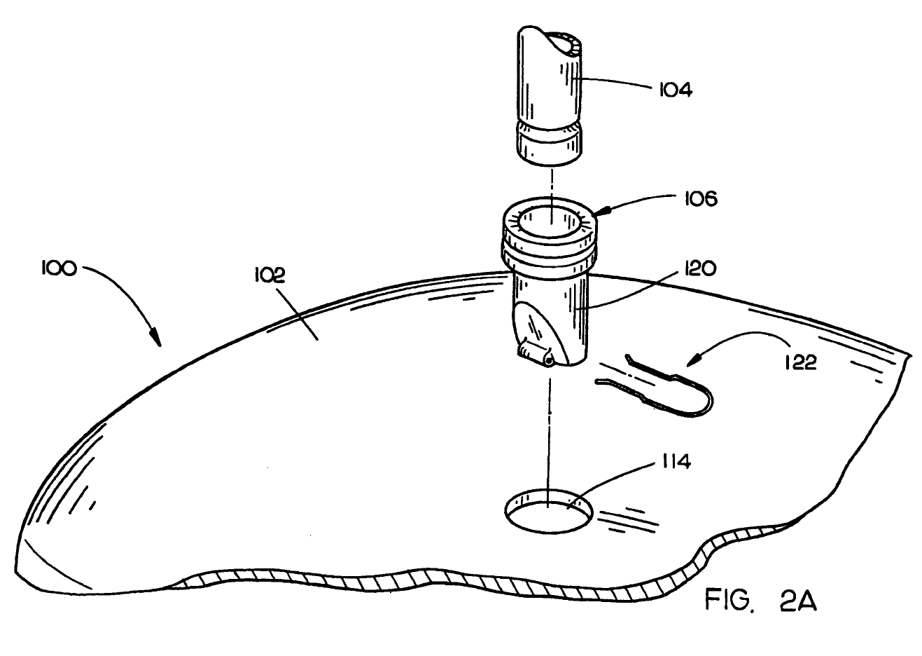

In the embodiment shown in FIG. 3, the air compressor 100 of the present invention further comprises a drain valve assembly 124 for draining fluid from the air storage tank 102. The drain valve assembly 124 includes a support ring 126, a valve 128 coupled to the support ring 126, and a drain valve seal 106. In the illustrated embodiment, the valve 128 is opened for draining fluid from the air storage tank 102. The valve 128 may be constructed of a variety of materials such as steel, brass, stainless steel, or the like. Referring generally to FIGS. 1A-1C and FIGS. 3-5, the drain valve seal 106 includes a body 108 having an external surface and an internal surface. The body 108 further includes an aperture 110 formed therein for receiving the support ring 126. A seal groove 112 is disposed in the external surface of the body 108 for securing the body 108 within an orifice 114 formed in a wall of the air storage tank 102, at least proximate to the lowest point of the air storage tank 102. A support ring retention collar 116 is disposed on the internal surface of the body 108 for engaging the support ring 126 and securing the support ring 126 within the body 108. The support ring 126 may be of a type commonly referred to in the art as a split ring. In addition, the support ring 126 may be comprised of a variety of materials such as steel, brass, stainless steel, nickel-plated brass, zinc-plated steel, or the like. The seal groove 112 engages the wall of the air storage tank 102 so that the support ring retention collar 116 is located within the air storage tank 102. Pressure within the air storage tank 102 causes the body 108 to deform about the support ring 126 for engaging the support ring retention collar 116 with the support ring 126 to secure the support ring 126 within the aperture 110. Comprised of a rigid material, the support ring 126 reinforces the drain valve seal 106 by supplying a radial force outward that prevents the drain valve seal 106 from collapsing inward under pressure. To disengage the valve 128, a user may simply push or tilt the portion of the valve 128 located on the outside of the air storage tank 102. This allows the pressure inside the air storage tank 102 to decrease by providing an open path for fluid to flow through the drain valve seal 106 and out to an area of lower pressure.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A tube seal for a pressure vessel, comprising:
a body having an aperture formed therein for receiving a tube, the body having an external surface and an internal surface;
a seal groove disposed in the external surface of the body for securing the body within an orifice formed in a wall of the pressure vessel; and
a tube retention collar disposed on the internal surface of the body, the tube retention collar for engaging the tube and securing the tube within the tube seal,
wherein pressure within the pressure vessel causes the body to deform about the tube for engaging the tube retention collar with the tube to secure the tube within the aperture.

2. The tube seal as claimed in claim 1, wherein the tube retention collar engages a channel formed in an external surface of the tube.

3. The tube seal as claimed in claim 2, wherein the tube retention collar is generally ramped for providing a tube engaging face for engaging the channel.

4. The tube seal as claimed in claim 2, wherein the body comprises an inner surface and an outer surface, the tube engaging face being disposed on the internal surface adjacent to the inner surface.

5. The tube seal as claimed in claim 2, wherein the channel formed in the tube comprises a ramped surface for providing a seal engaging face for engaging the tube engaging face of the retention collar.

6. The tube seal as claimed in claim 1, wherein the seal groove engages the wall of the pressure vessel, the seal groove being positioned so that the tube retention collar is located within the pressure vessel.

7. The tube seal as claimed in claim 1, wherein the body is formed of an elastomer material for allowing elastic deformation of the body.

8. The tube seal as claimed in claim 1, further comprising a check valve for providing a unidirectional flow of fluid through the tube.

9. The tube seal as claimed in claim 8, wherein the check valve comprises a duck-bill check valve.

10. The tube seal as claimed in claim 9, further comprising a spring assembly for biasing the check valve to one of an opened or a closed position.

11. The tube seal as claimed in claim 1, wherein the tube comprises a drain valve assembly for draining fluid from the pressure vessel.

12. The tube seal as claimed in claim 11, wherein the drain valve assembly comprises a support ring for being engaged by the tube retention collar and a valve coupled with the support ring, the valve being opened for draining fluid from the pressure vessel.

13. An air compressor, comprising:
an air storage tank for storing air under pressure;
a tube for at least one of supplying compressed air to the air storage tank and removing compressed air from the air storage tank;
a tube seal for coupling the tube to the air storage tank, the tube seal including:
a body having an aperture formed therein for receiving a tube, the body having an external surface and an internal surface;
a seal groove disposed in the external surface of the body for securing the body within an orifice formed in a wall of the air storage tank; and
a tube retention collar disposed on the internal surface of the body, the tube retention collar for engaging the tube and securing the tube within the tube seal,
wherein pressure within the air storage tank causes the body to deform about the tube for engaging the tube retention collar with the tube to secure the tube within the body.

14. The air compressor as claimed in claim 13, wherein the tube retention collar comprises a generally ramped surface and a tube engaging face for engaging a channel formed in an external surface of the tube, the channel including a second generally ramped surface and a seal engaging face for engaging the tube engaging face of the retention collar.

15. The air compressor as claimed in claim 13, wherein the body of the tube seal is formed of an elastomer material for allowing elastic deformation of the body.

16. The air compressor as claimed in claim 13, wherein the tube seal further comprises a check valve for providing a unidirectional flow of air through the tube.

17. The air compressor as claimed in claim 16, wherein the check valve comprises a duck-bill check valve.

18. The air compressor as claimed in claim 17, further comprising a spring assembly for biasing the check valve to one of an opened or a closed position.

19. The air compressor as claimed in claim 13, further comprising a drain valve assembly for draining fluid from the air storage tank, the drain valve assembly including:
a support ring;
a valve coupled to the support ring, the valve being opened for draining fluid from the air storage tank;
a drain valve seal, including:
a body having an aperture formed therein for receiving the support ring, the body having an external surface and an internal surface;
a seal groove disposed in the external surface of the body for securing the body within an orifice formed in a wall of the air storage tank at least proximate to the lowest point of the air storage tank; and
a support ring retention collar disposed on the internal surface of the body, the support ring retention collar for engaging the support ring and securing the support ring within the body,
wherein pressure within the air storage tank causes the body to deform about the support ring for engaging the support ring retention collar with the support ring to secure the support ring within the aperture.

20. A tube seal for a pressure vessel, comprising:
means for receiving a tube;
means for securing the tube receiving means within an orifice formed in a wall of the pressure vessel; and
means for engaging the tube and securing the tube within the tube receiving means,
wherein pressure within the pressure vessel causes the tube receiving means to deform about the tube for engaging the tube engaging means with the tube to secure the tube within the tube receiving means.
